(19) United States
(12) Patent Application Publication
(10) Pub. No.: US 2025/0334151 A1
(43) Pub. Date: Oct. 30, 2025

(54) RIGID-FLOATING FLEXIBLE TORQUE COUPLER

(71) Applicant: Raytheon Company, Tewksbury, MA (US)

(72) Inventor: Chang J. Yee, STOW, MA (US)

(21) Appl. No.: 18/646,204

(22) Filed: Apr. 25, 2024

(51) Int. Cl. F16D 3/18

(52) U.S. Cl. CPC F16D 3/18

(57) ABSTRACT

A rigid-floating flexible torque coupler includes a pair of ball-and-socket joints attached to opposite ends of a rigid shaft that form a single torque shaft. Each socket is configured to be rigidly attached, and possibly integrally formed, to a drive/driven shaft. Each ball-and-socket has opposing ball and socket surfaces that interfere and to prevent rotation of the ball relative to the socket to transfer torque upon rotation of the drive shaft while allowing the ball to pivot within the socket to tolerate lateral or angular offsets of the drive and driven shafts. Each socket may have sufficient depth to allow the ball (single torque shaft) to be displaced axially to tolerate axial misalignment of the drive and driven shafts. The single torque shaft is not rigidly attached. At rest in a nominally aligned state, the single torque shaft and balls “float” within the pair of sockets. In operation, the points of interference of the opposing surface may be constantly changing depending on the misalignment while maintaining the transfer of torque.

### GOVERNMENT LICENSE RIGHTS

This disclosure was made with government support. The government has certain rights in this invention.

### BACKGROUND

### Field

This disclosure relates to torque couplers used to transmit energy from a drive side to a driven side in a rotary system, and more particularly to flexible torque couplers, which can be used to connect slightly misaligned shafts.

### Description of the Related Art

Torque couplers are mechanical elements or systems used to transmit energy from a drive shaft to a driven shaft in a rotary system. In an XYZ coordinate system in which the shafts are nominally aligned along the X-axis, energy is transmitted via rotation about the X-axis.

One class of torque couplers is referred to a “rigid couplings”, which connect the drive shaft and driven shaft with a solid and high-precision hold that efficiently transfer torque through the coupling. Rigid couplings cannot tolerate any misalignment of the drive and driven shaft.

A second class of torque couplers is referred to as “flexible couplings”, which can be used to couple slightly misaligned shafts but typically cannot provide the same level of torque transfer. Misalignment between the drive and driven shafts may occur in any one or more of the remaining 5 degrees of freedom (DOF); a displacement along X, Y or Z or rotation around Y or Z. A displacement along the X axis is referred to as “Axial Misalignment”, displacement along the Y or Z axes is referred to as a “Radial (Lateral) Offset” and rotation about the Y or Z axes is referred to as “Angular Offset”. Flexible couplings include, for example, precision cut, bellows, elastomer and universal joint couplers.

Depending on the application each type of coupler may have advantages and or disadvantages when compared to each other. Couplers will exhibit quantifiable capabilities such as maximum torque, back-lash, maximum angular misalignment, maximum radial misalignment, operating temperature range, and or other operating environments. Couplers can also be quite mechanically complex in its design when trying to focus on some or all these capabilities.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure provides a rigid-floating flexible torque coupler that includes a pair of ball-and-socket joints attached to opposite ends of a rigid shaft to form a single torque shaft. Each socket is configured to be rigidly attached, and possibly integrally formed, to a drive/driven shaft. Each ball-and-socket has opposing ball and socket surfaces that interfere to prevent rotation of the ball relative to the socket to transfer torque upon rotation of the drive shaft while allowing the ball to pivot within the socket to tolerate lateral or angular offsets of the drive and driven shafts. Each socket may have sufficient depth to allow the ball (single torque shaft) to be displaced axially to tolerate axial misalignment of the drive and driven shafts. The single torque shaft is not rigidly attached. At rest in a nominally aligned state, the single torque shaft and balls “float” within the pair of sockets. In operation, the points of interference of the opposing surface may be constantly changing depending on the misalignment while maintaining the transfer of torque.

In different embodiments, the opposing ball and socket surfaces are non-spherical with portions of their cross-sections being non-tangential to a circle about the rotation axis of the socket such that the opposing surfaces interfere and transfer torque. For stability and efficiency of torque transfer, the ball and socket surfaces are preferably symmetric about a center axis of the ball and the rotation axis of the socket, respectively. For example, the ball and socket surfaces may have a polygonally-shaped cross-section such as triangles, squares, hexagons etc. that mirror each other. Alternately, the ball and socket may have different polygonally-shaped cross-sections such as a triangle within a hexagon. The distance between the vertices on the surface of the ball in cross-section is greater than the distance between flat surfaces on the surface of the socket in cross-section such that a rotation of the ball relative to the socket will cause the vertices of the ball to contact (interfere with) the flat surfaces of the socket. Alternately, the ball and socket may have more complex shapes that interfere. In an embodiment, each ball and socket has opposing surfaces that form a co-axial gear mesh about the axis of the shaft to which the socket is rigidly attached. Rotation of either the socket or ball causes the surfaces or teeth to interfere and transfer torque. As with gears, the more surfaces or teeth, the smoother the transfer of torque.

In different embodiments, to define a profile that allows the ball to pivot in two-dimensions, the ball has a maximum width perpendicular to the axis of the single torque shaft and tapers fore and aft to a lesser width in cross-section. The ball pivots about a plurality of points of contact (interference) between the ball (singular torque shaft) and socket over a specified angular range relative to the axis without interfering.

In different embodiments, the ball-and-sockets may have either identical or different size and shape to include identical or different cross-sections and profiles.

These and other features and advantages of the disclosure will be apparent to those skilled in the art from the following detailed description of preferred embodiments, taken together with the accompanying drawings, in which:

### BRIEF DESCRIPTION OF THE DRAWINGS

FIGS. 1A-1E are different views of a flexible torque coupler that can withstand misalignment of the drive and driven shafts in 5 DOF;

FIGS. 2A and 2B are section view perpendicular to and along the axis of rotation illustrating the engagement of the ball and socket to transfer energy;

FIGS. 3A-3D are section views along the axis of rotation illustrating Axial Misalignment, Radial (Lateral) Misalignment, singular Angular Offset and non-singular Angular Offset, respectfully;

FIGS. 4A-4B are perspective views of alternate embodiments of the ball end of the torque coupler and socket; and

FIG. 5A-5B are a view of an alternate embodiment of a flexible torque coupler in which only axial misalignment is tolerated.

### DETAILED DESCRIPTION

The present disclosure describes a rigid-floating flexible torque coupler that includes a pair of ball-and-socket joints attached to opposite ends of a rigid shaft. The rigid shaft and balls forming a single torque shaft. Each socket is configured to be rigidly attached, and possibly integrally formed, to a drive/driven shaft. Each ball-and-socket has opposing ball and socket surfaces that interfere to prevent rotation of the ball relative to the socket to transfer torque upon rotation of the drive shaft while allowing the ball to pivot within the socket to tolerate lateral or angular offsets of the drive and driven shafts. Each socket may have sufficient depth to allow the ball (single torque shaft) to be displaced axially to tolerate axial misalignment of the drive and driven shafts. The single torque shaft is not rigidly attached. At rest in a nominally aligned state, the single torque shaft and balls “float” within the pair of sockets. In operation, the points of interference of the opposing surface may be constantly changing depending on the misalignment while maintaining the transfer of torque.

The opposing ball and socket surfaces are non-spherical with portions of their cross-sections being non-tangential to a circle about the rotation axis of the socket such that the opposing surfaces interfere and transfer torque. For stability and efficiency of torque transfer, the ball and socket surfaces are preferably symmetric about a center axis of the ball and the rotation axis of the socket, respectively. The profile of the ball relative to the socket is configured to allow the ball and singular torque shaft to rotate about a specified angle without interfering with the socket. The ball and socket surfaces may be polygonally-shaped in cross-section or profile or may form a co-axial gear mesh. Any complementary shapes that serve to interfere and transfer torque in rotation while allowing the ball to pivot about the axis may be suitable.

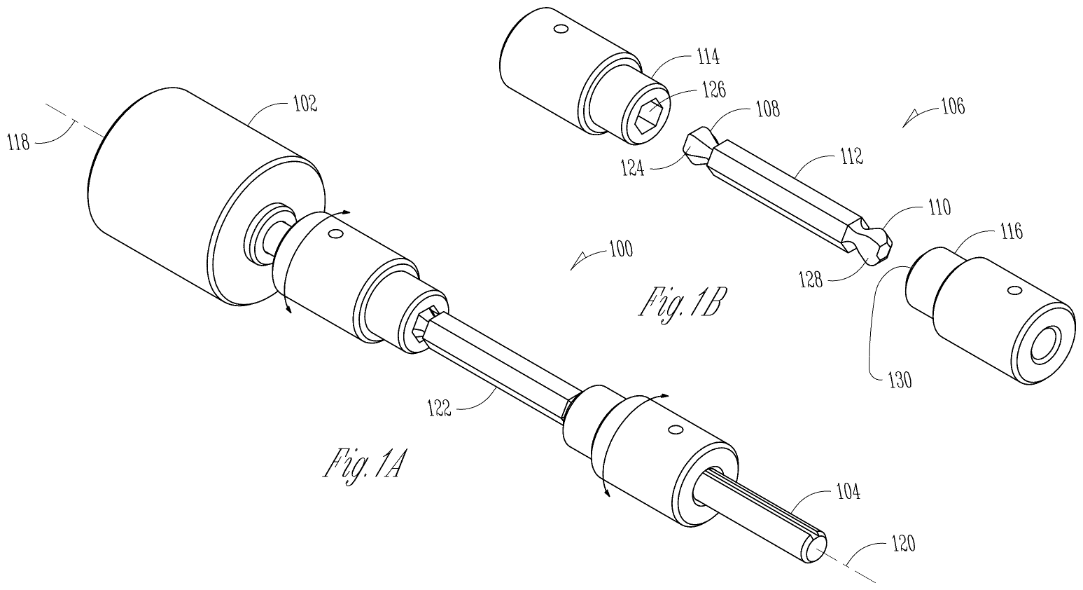

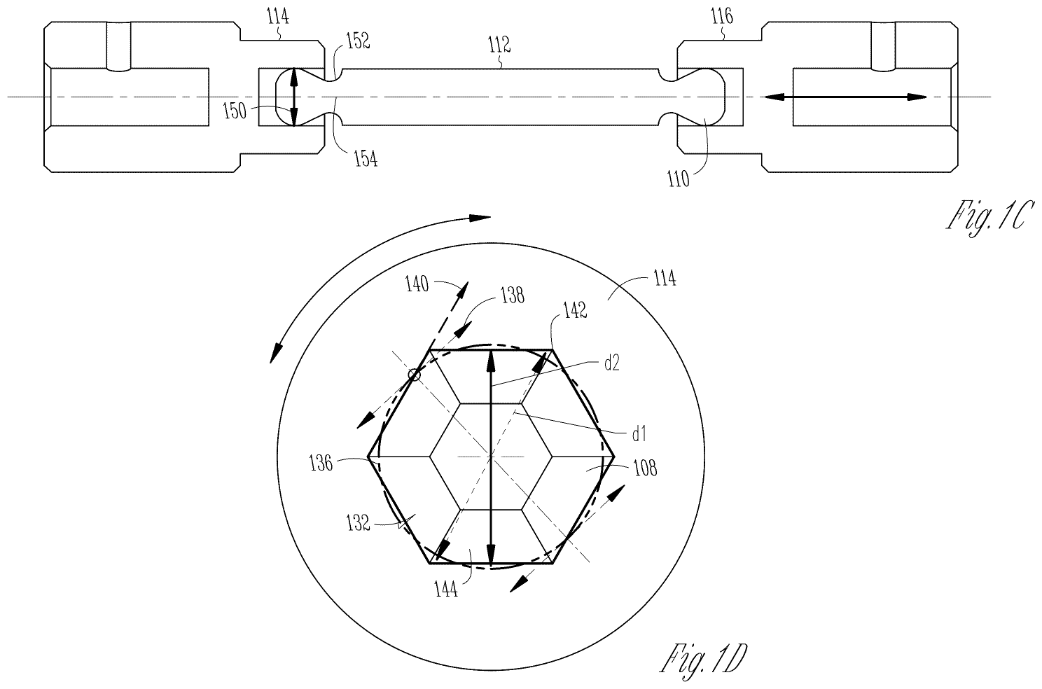

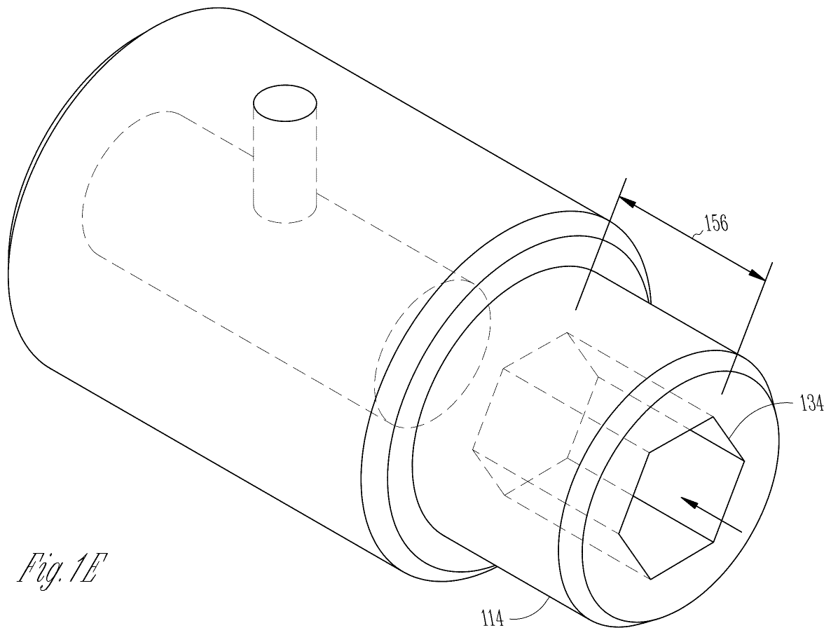

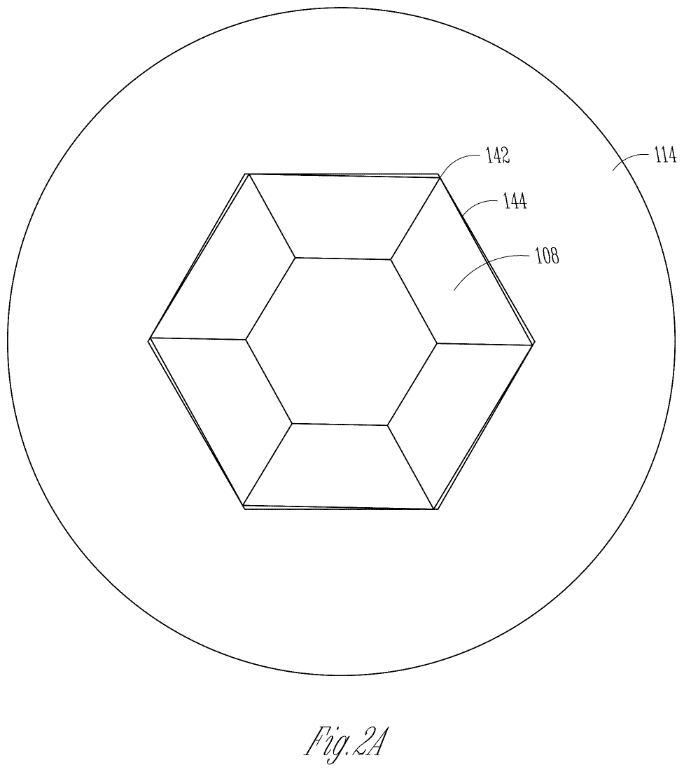

Referring now to FIGS. 1A-1E, an embodiment of a rigid-floating flexible torque coupler (“coupler”) 100 is illustrated in an aligned or co-axial state at rest. Coupler 100 is configured to transfer torque between drive shaft 102 and driven shaft 104 and to tolerate a degree of lateral and angular offset and axial misalignment between drive shaft 102 and driven shaft 104.

Coupler 100 includes a single torque shaft 106 in which balls 108 and 110 are rigidly attached or integrally formed at opposing ends of a rigid shaft 112. Sockets 114 and 116 are rigidly attached to or integrally formed with the drive and driven shafts 102 and 104 and configured to receive balls 108 and 110. Drive shaft 102 and socket 114 are co-axial along an axis of rotation 118. Driven shaft 104 and socket 116 are co-axial along an axis of rotation 120. Balls 108 and 110 and rigid shaft 112 are co-axial along an axis of rotation 122. In the aligned state, the axes of rotation 118, 120 and 122 are nominally co-axial.

Ball 108 and socket 114 (ball 110 and socket 116) have opposing ball and socket surfaces 124 and 126 (128 and 130) that interfere with each other to transfer torque upon rotation of drive shaft 102 while allowing balls 108 and 110 to tolerate lateral or angular offset of the driven and driven shafts 102 and 104. The sockets 114 and 116 are suitably formed with sufficient depth along the axis of rotation to tolerate axial misalignment of the drive and driven shafts.

In this illustrated embodiment, balls 108 and 110 are identical in size and shape and have a hexagonal cross-section 132. Sockets 114 and 116 are also identical in size and shape and have a hexagonal cross-section 134, which is slightly larger than the ball to provide clearance. At the vertices and the mid-points of the sides of the hexagonal cross-section, the surfaces are tangential to a circle 136 about the axis. However, the remaining portions of the surfaces, which constitutes the majority of the surface area, is non-tangential to the surface. For example, line 138 is tangent to circle 136 and line 140 (on the surface of the hexagonal cross-section) is non-tangential to circle 136.

The distance d1 between the vertices 142 on the surface of the ball in cross-section 132 is greater than the distance d2 between flat surfaces 144 on the surface of the socket cross-section 134 such that a rotation of the ball relative to the socket will cause the vertices 142 of the ball to contact (interfere with) the flat surfaces 144 of the socket and transfer torque.

The profile of the ball 108 (110) relative to the socket 114 (116) is configured to allow the ball and rigid shaft to rotate about a specified angle without interfering with the socket. Each ball has a maximum width 150 perpendicular to the axis of the single torque shaft. Each ball tapers fore and aft to a lesser width. In other words, there is a “neck” 152 between the rigid shaft and the ball and the ball tapers to an end 154 having a reduced diameter. The socket has a uniform profile 156 e.g., a hexagonal cylinder along the axis.

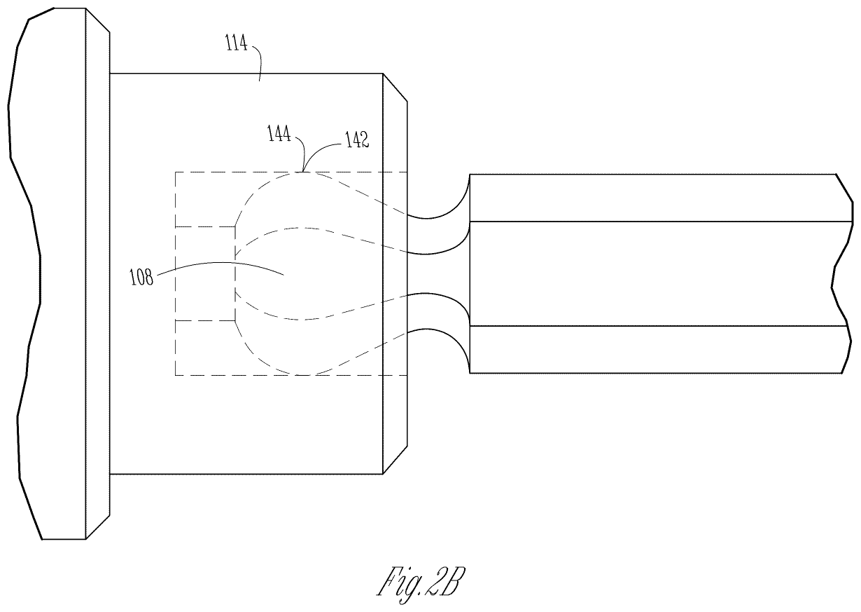

Referring now to FIGS. 2A-2B, coupler 100 is illustrated in an aligned or co-axial state at in which torque is constantly applied to drive shaft 102.

At rest (i.e. no torque applied to drive shaft 102), the single torque shaft 106 will settle down and rest at a state of equilibrium. Potential surfaces of contact, between the ball and socket, will be influenced by factors such as the effects of gravity, spacing from design, spacing from fabrication tolerance, weight, friction, and by chance. When torque is initially applied (i.e. drive shaft 102 turns but not enough for the torque shaft 106 to rotate appreciably), the torque shaft 106 will likely shift, ever so slightly, to a new state of equilibrium.

When torque is constantly applied to the drive shaft 102, causing the torque shaft 106 to rotate, the potential points or surfaces of contact, between the ball end and and, will be changing dynamically. This especially true when there is an angular offset between the torque shaft and input/output shafts. In addition to the factors when at rest, other factors, such as the dynamically changing contact surface areas and geometry profiles, become most relevant. As shown in FIG. 2A, in cross-section the six vertices 142 of the hexagonal ball contact (or interfere with) the six surfaces 144 of the socket. The number of points of contact and which vertices 142 (in which cross-sectional plane of the ball) contact the socket will change dynamically with misalignment.

When torque is reversed or oscillates, there will likely be a combination of the above stated scenarios.

Ideally the efficiency of torque transfer between the input shaft and output shaft should be maximized. This would be achieved mainly through geometry design and material selection.

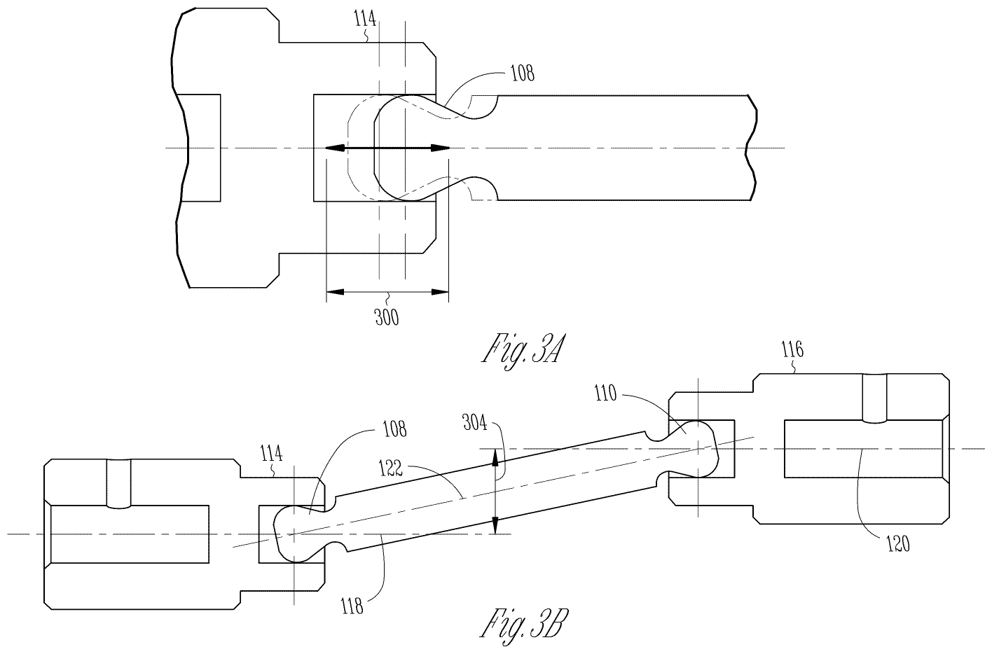

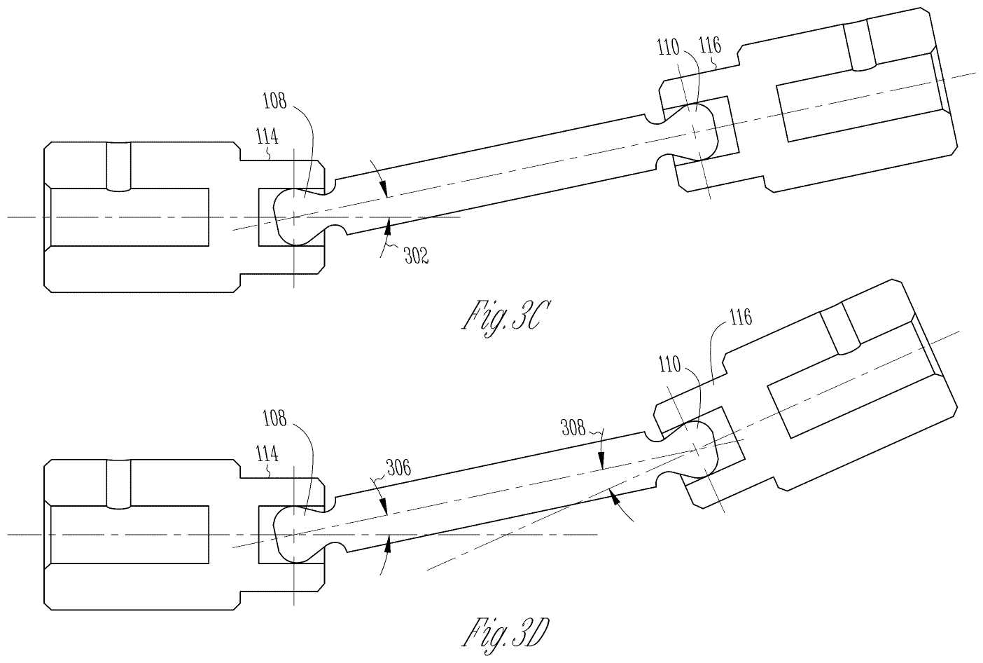

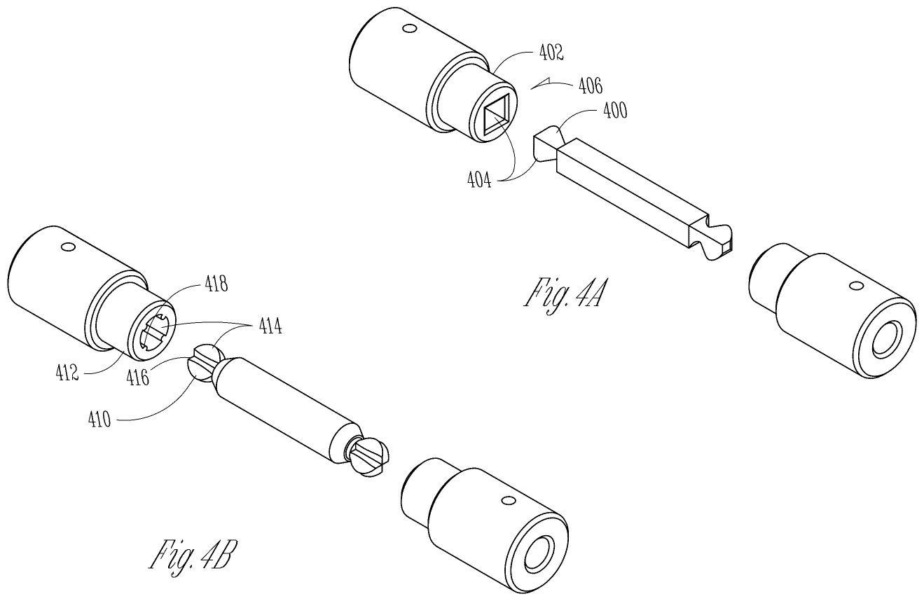

Referring now to FIGS. 3A-3D, the relationship of balls 108 and 110 and sockets 114 and 116 to tolerate axial misalignment, radial (lateral) offset, single angular offset or non-singular angular offset, respectively, while maintaining the interference required to transfer torque is depicted.

As shown in FIG. 3A, socket 114 has sufficient or additional depth along the axis to allow ball 108 (and single torque shaft) to be displaced along the axis to tolerate axial misalignment of the drive and driven shafts within a specified range 300.

As shown in FIG. 3B, if the drive/driven shafts are offset radially (laterally), the sockets 114 and 116 are also offset. Balls 108 and 110 pivot in sockets 114 and 116 to accommodate the radial (lateral) offset within a specified range 302.

As shown in FIG. 3C, if the drive/drive shafts have a singular angular offset, ball 108 pivots within socket 114 to accommodate the offset within a specified range 304.

As shown in FIG. 3D, if the drive/drive shafts have a non-singular angular offset, ball 108 pivots within socket 114 and ball 110 pivots within socket 116 to accommodate the compound offset within specified ranges 306 and 308.

In all cases, provided the misalignment is within the specified range, when torque is constantly applied via the drive shaft, the ball and socket will interfere at multiple points/surfaces to transfer torque through the coupler to the driven shaft.

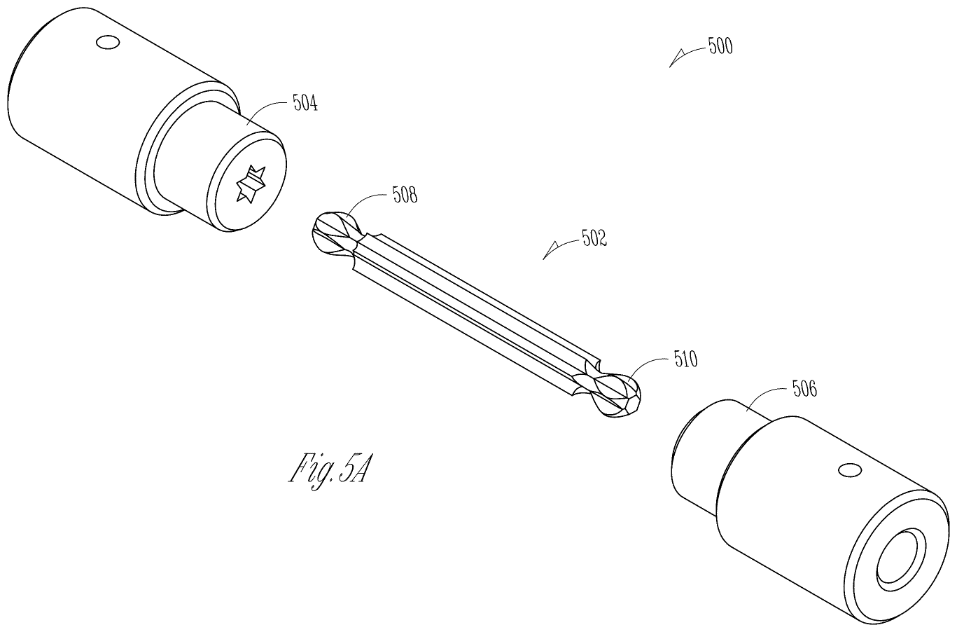

Referring now to FIGS. 4A-4B, alternate configurations of the ball and socket to provide torque transfer and allow for radial (lateral) or angular misalignment are depicted. In FIG. 4A, the ball 400 and socket 402 have square cross-sections 404 that interfere to transfer torque. As shown, the outer surface of socket 402 has a chamfer 406 that increases the range the ball/shaft can pivot before interfering with the socket. In FIG. 4B, the ball 410 and socket 412 have co-axial gear mesh cross-sections 414 that interfere to transfer torque. The ball teeth 416 engage the socket teeth 418 to transfer torque while the profile of the ball allows it to pivot in the socket. The greater the number of teeth, the smoother the ball-and-socket will operate to transfer torque.

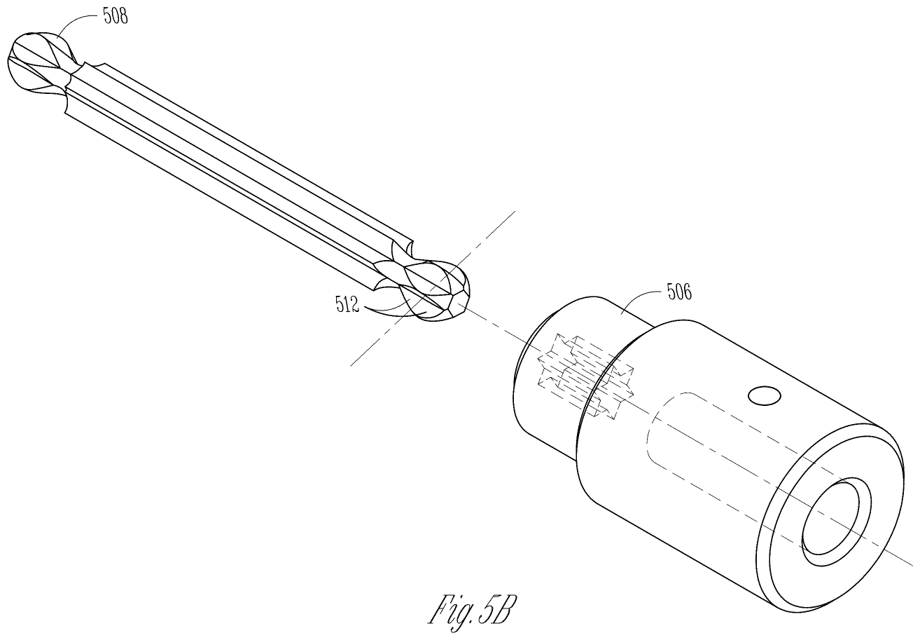

Referring now to FIGS. 5A-5B, an embodiment of a coupler 500 includes a single torque shaft 502 and sockets 504 and 506, in which the balls 508 and 510 and sockets 504 and 506 are designed to transfer torque and to allow only axial misalignment over a specified range. The balls and sockets have a star shaped cross section 512. Any pivoting of the ball is minimal and attributable to the minimum clearance that must be provided between the ball and socket.

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

I claim:

1. A rigid-floating flexible torque coupler to couple torque from a drive shaft that rotates about an axis to a driven shaft, the flexible coupler comprising:
a single torque shaft including first and second balls rigidly attached at opposing ends of a rigid shaft;
a first socket configured to be rigidly attached to the drive shaft, said first socket configured to receive the first ball;
a second socket configured to be rigidly attached to the driven shaft, said second socket configured to receive the second ball;
wherein said first socket and first ball and said second socket and second ball are each configured with opposing ball and socket surfaces that interfere to transfer torque upon rotation of the drive shaft about the axis while allowing the ball to pivot within the socket to tolerate lateral or angular offset of the drive and driven shafts.

2. The rigid-floating flexible torque coupler of claim 1, wherein at rest in a nominally aligned condition, the single torque shaft and first and second balls float within the first and second sockets.

3. The rigid-floating flexible torque coupler of claim 1, wherein the opposing ball and socket surfaces are configured to interfere with each other at a plurality of points to transfer torque, wherein the composition of the plurality of points changes dynamically depending on the lateral or angular offset.

4. The rigid-floating flexible torque coupler of claim 1, wherein portions of the cross-sections of the opposing ball and socket surfaces are non-tangential to a circle about a rotation axis of the socket.

5. The rigid-floating flexible torque coupler of claim 1, wherein the opposing ball and socket surfaces are symmetric about a center axis of the ball and a rotation axis of the socket.

6. The rigid-floating flexible torque coupler of claim 4, wherein the opposing ball and socket surfaces have a polygonally-shaped cross-section perpendicular to the rotation axis of the socket and the single torque shaft, respectively.

7. The rigid-floating flexible torque coupler of claim 4, wherein the opposing ball and socket surfaces form a co-axial gear mesh to transfer torque.

8. The rigid-floating flexible torque coupler of claim 1, wherein each ball has a maximum width perpendicular to the axis of the single torque shaft, wherein each ball tapers fore and aft to a lesser width.

9. The rigid-floating flexible torque coupler of claim 8, wherein the opposing surfaces are configured to interfere at a plurality of points to transfer torque, wherein each ball pivots about the plurality of points over a defined range without interfering with the socket.

10. The rigid-floating flexible torque coupler of claim 1, wherein the first and second sockets are integrally formed in the ends of the drive and driven shafts, respectively.

11. The rigid-floating flexible torque coupler of claim 1, wherein said first and second sockets have sufficient depth along the axis to allow the first and second balls to be displaced along the axis to tolerate axial misalignment of the drive and driven shafts.

12. A rigid-floating flexible torque coupler to couple torque from a drive shaft that rotates about an axis to a driven shaft, the flexible coupler comprising:
first and second ball-and-socket joints in which the balls are rigidly attached at opposing ends of a rigid shaft, wherein the sockets are configured to be rigidly attached to the drive shaft or the driven shaft,
wherein said first and second ball-and-socket joints are each configured with opposing ball and socket surfaces that interfere to transfer torque upon rotation of the drive shaft about the axis while allowing the ball to pivot within the socket to tolerate lateral or angular offset of the drive and driven shafts.

13. The rigid-floating flexible torque coupler of claim 12, wherein at rest in a nominally aligned condition, the single torque shaft and first and second balls float within the first and second sockets, wherein the opposing ball and socket surfaces are configured to interfere with each other at a plurality of points to transfer torque, wherein the composition of the plurality of points changes dynamically depending on the lateral or angular offset.

14. The rigid-floating flexible torque coupler of claim 12, wherein portions of the cross-sections of the opposing ball and socket surfaces are non-tangential to a circle about a rotation axis of the socket.

15. The rigid-floating flexible torque coupler of claim 12, wherein the first and second sockets are integrally formed in the ends of the drive and driven shafts, respectively.

16. A rigid-floating flexible torque coupler to couple torque from a drive shaft that rotates about an axis to a driven shaft, the flexible coupler comprising:
first and second ball-and-socket joints in which the balls are rigidly attached at opposing ends of a rigid shaft, wherein the sockets are configured to be rigidly attached to the drive shaft or the driven shaft,
wherein said first and second ball-and-socket joints are each configured with opposing ball and socket surfaces that interfere to transfer torque upon rotation of the drive shaft about the axis while allowing the ball to be displaced axially within the socket to tolerate axial misalignment of the drive and driven shafts.

17. The rigid-floating flexible torque coupler of claim 16, wherein at rest in a nominally aligned condition, the single torque shaft and first and second balls float within the first and second sockets, wherein the opposing ball and socket surfaces are configured to interfere with each other at a plurality of points to transfer torque, wherein the composition of the plurality of points changes dynamically depending on the lateral or angular offset.

18. The rigid-floating flexible torque coupler of claim 16, wherein portions of the cross-sections of the opposing ball and socket surfaces are non-tangential to a circle about a rotation axis of the socket.

19. The rigid-floating flexible torque coupler of claim 16, wherein the first and second sockets are integrally formed in the ends of the drive and driven shafts, respectively.
